(19) United States
(12) Patent Application Publication
(10) Pub. No.: US 2014/0063879 A1
(43) Pub. Date: Mar. 6, 2014

(54) RECTIFIER CIRCUIT AND ELECTRONIC DEVICE USING SAME

(71) Applicant: HON HAI PRECISION INDUSTRY CO., LTD., New Taipei (TW)

(72) Inventors: KAI-FU CHEN, New Taipei (TW); CHUANG-WEI TSENG, New Taipei (TW); CHE-HSUN CHEN, New Taipei (TW)

(73) Assignee: HON HAI PRECISION INDUSTRY CO., LTD., New Taipei (TW)

(21) Appl. No.: 14/014,399

(22) Filed: Aug. 30, 2013

(30) Foreign Application Priority Data
Sep. 4, 2012 (TW) 101132154

(51) Int. Cl. H02M 7/217

(52) U.S. Cl. CPC H02M 7/217
USPC 363/89

(57) ABSTRACT

A rectifier circuit includes a three-phase alternating current (AC) voltage, a first rectifier unit, a second rectifier unit, a third rectifier unit, a first voltage output terminal, a second voltage output terminal, a first energy storing circuit and a second energy storing circuit. The three-phase AC voltage generates a first AC voltage, a second AC voltage, and a third AC voltage, and outputs them to the first rectifier circuit, a second rectifier circuit, and a third rectifier circuit correspondingly. The first energy storing circuit and the second storing circuit are connected in series and are coupled between the first voltage output terminal and the second voltage output terminal, to drive a load. In a positive period of each AC voltage, the second energy storing circuit is charged by each rectifier unit. In a negative period of each AC voltage, the first energy storing circuit is charged by each rectifier unit.

### BACKGROUND

1. Technical Field

The present disclosure relates to voltage rectifying technologies, and more particularly to a rectifier circuit having a power factor correction function and an electronic device using the same.

2. Description of Related Art

When an alternating current (AC) voltage is converted into a direct current (DC) voltage, a converter is used. A boost circuit can be used as a converter. A DC voltage generated by the converter can be too great that the DC voltage cannot be directly used by an electronic device. Thus, a transformer is needed to convert the DC voltage into a suitable voltage for the electronic device. However, the circuit will require more space to place the transformer.

Therefore, what is needed is to provide a means that can overcome the above-described limitations.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views, and all the views are schematic.

FIG. 1 is a circuit diagram of a rectifier circuit according to one embodiment of the present disclosure; the rectifier circuit includes a signal generating unit, a first switch, and a three-phase AC power supply.

FIG. 2 is a block diagram of the signal generating unit of FIG. 1.

FIG. 3 is a circuit diagram of the first switch of FIG. 1.

FIG. 4 is a waveform diagram of a first AC voltage, a second AC voltage, and a third AC voltage generated by the three-phase AC power supply of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

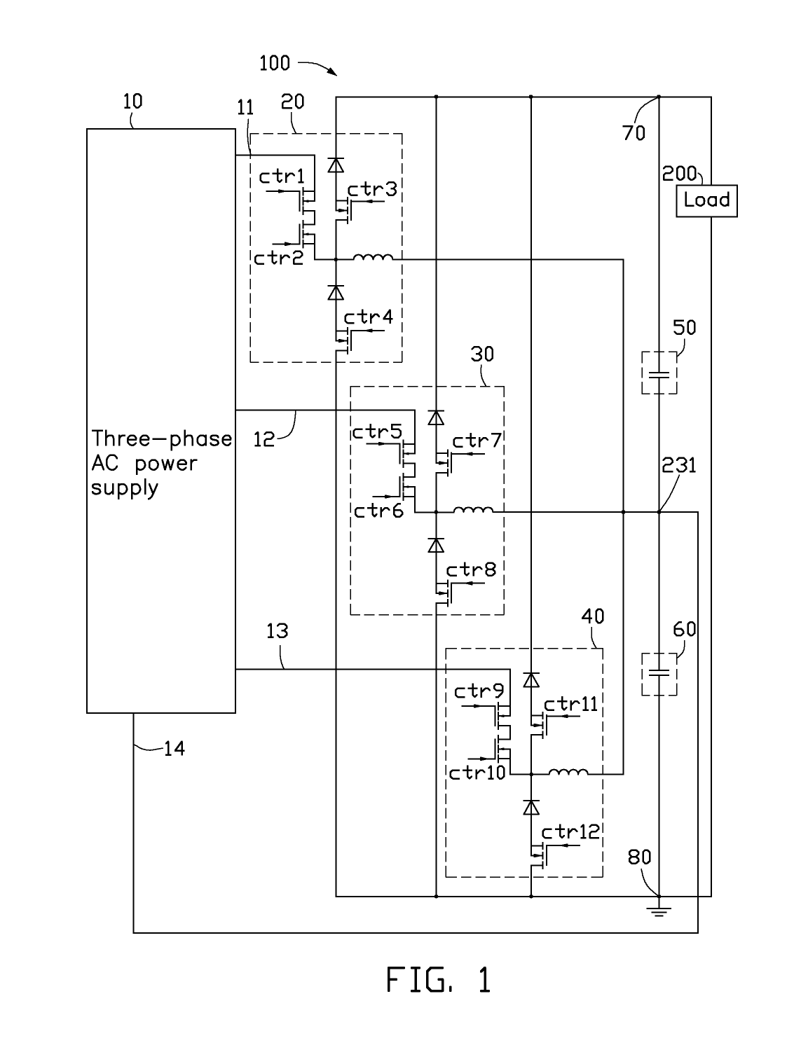

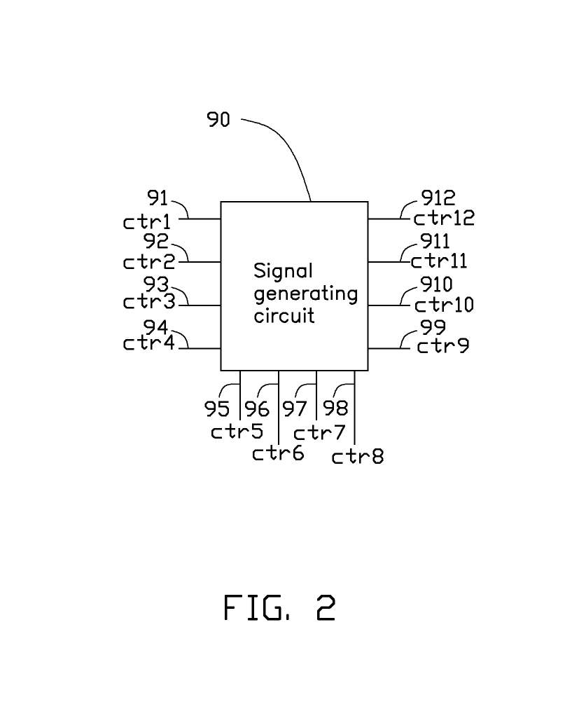

FIG. 1 is a circuit diagram of a rectifier circuit 100 according to one embodiment of the present disclosure; the rectifier circuit includes a signal generating unit, a first switch, and a three-phase AC power supply. The rectifier circuit 100 is adapted to provide a driving voltage to a load 200. The rectifier circuit 100 includes a three-phase AC power supply 10, a first rectifier unit 20, a second rectifier unit 30, a third rectifier unit 40, a first energy storing circuit 50, a second energy storing circuit 60, a first voltage output terminal 70, a second voltage output terminal 80, and a signal generating unit 90 (see FIG. 2)

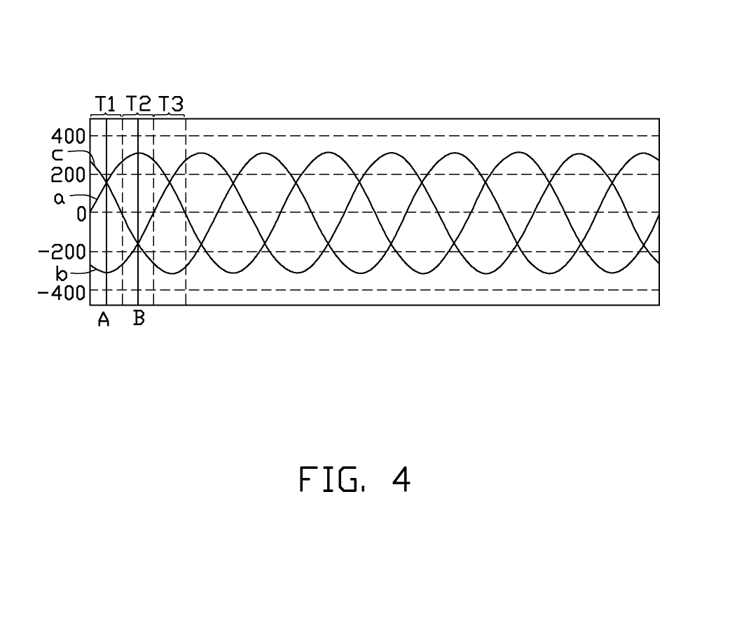

The three-phase AC power supply 10 includes a first AC voltage output terminal 11, a second AC voltage output terminal 12, a third AC voltage output terminal 13, and a common terminal 14. The three-phase AC power supply 10 generates a first AC voltage, a second AC voltage, and a third AC voltage. The first AC voltage, the second AC voltage, and the third AC voltage have a same frequency. Phase differences between the first AC voltage and the second AC voltage, the second AC voltage and the third AC voltage, and the third AC voltage and the first AC voltage, are each 120 degrees (in one example), as shown in FIG. 4. The first AC voltage is output via the first AC voltage output terminal 11 and the common terminal 14. The second AC voltage is output via the second AC voltage output terminal 12 and the common terminal 14. The third AC voltage is output via the third AC voltage output terminal 13 and the common terminal 14. The first AC voltage, the second AC voltage, and the third AC voltage each has a periodic and sinusoidal waveform. The sinusoidal waveform includes a positive period and a negative period. A voltage value of the AC voltage is greater than zero in the positive period, and less than zero in the negative period.

The first rectifier unit 20 receives the first AC voltage and discharges to the first energy storing circuit 50 and the second energy storing circuit 60. The second rectifier unit 30 receives the second AC voltage and discharges to the first energy storing circuit 50 and the second energy storing circuit 60. The third rectifier unit 40 receives the third AC voltage and discharges to the first energy storing circuit 50 and the second energy storing circuit 60. The first energy storing circuit 50 and the second energy storing circuit 60 store energy, and converts the energy into a DC voltage. The DC voltage serves as a driving voltage for the load 200.

Referring to FIG. 2, the signal generating unit 90 includes twelve terminals. The twelve terminals are a first terminal 91, a second terminal 92, a third terminal 93, a fourth terminal 94, a fifth terminal 95, a sixth terminal 96, a seventh terminal 97, an eighth terminal 98, a ninth terminal 99, a tenth terminal 910, an eleventh terminal 911, and a twelfth terminal 912. The signal generating unit 90 generates a first control signal, a second control signal, a third control signal, a fourth control signal, a fifth control signal, sixth control signal, a seventh control signal, an eighth control signal, a ninth control signal, a tenth control signal, an eleventh control signal, and a twelfth control signal. The control signals are output via the corresponding terminals. For example, the first control signal is output via the first terminal 91, the second control signal is output via the second terminal 92, and so on. The twelve control signals are periodic signals. In the embodiment, the control signals are pulse width modulation (PWM) signals. Duty ratio of the PWM signals can be modulated. Frequencies of the twelve control signals are greater than a frequency of the AC voltages. In the embodiment, the frequencies of the twelve control signals are integer times greater than the frequency of the AC voltages. Each of the control signals includes a first half period and a second half period. For example, a voltage of the first half period of the control signals is greater than zero, and a voltage of the second half period of the control signals is less than zero. In the embodiment, each first half period of the twelve control signals occurs at the same time, and each second half period of the twelve control signals occurs at the same time.

The first rectifier unit 20, the second rectifier unit 30, and the third rectifier unit 40 have substantially the same electronic components and connections. Hereafter, the first rectifier unit 20 will be described.

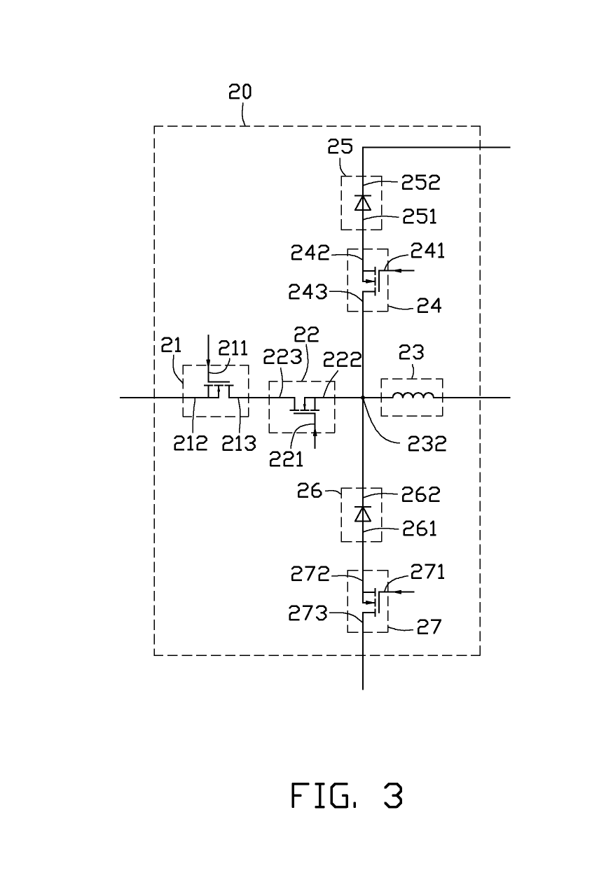

Referring to FIG. 3, the first rectifier unit 20 includes a first switch 21, a second switch 22, a first energy storing sub-unit 23, a third switch 24, a first unidirectional circuit 25, a second unidirectional circuit 26, and a fourth switch 27. In this embodiment, the first switch 21, the second switch 22, the third switch 24, and the fourth switch 27 are N-channel metal-oxide semiconductor field-effect transistors (NMOSFET). The first energy storing sub-unit 23 is an inductor.

The first switch 21 includes a first gate 211, a first drain 212, and a first source 213. The first gate 211 receives the first control signal output from the first terminal 91 and controls the first switch 21 to switch on or off according to the first control signal. The first drain 212 is electronically coupled to the first AC voltage output terminal 11 and the first drain 212 serves as an input terminal of the first rectifier unit 20. The second switch 22 includes a second gate 221, a second drain 222, and a second source 223. The second gate 221 receives the second control signal output from the second terminal 92 and controls the second switch 22 to switch on or off according to the second control signal. The second source 223 is electronically coupled to the first source 213. The second switch 22 switches on when the first switch 21 switches on, and the second switch 22 switches off when the first switch 21 switches off under control of the second control signal.

The first energy storing sub-unit 23 is connected between the second source 222 and a node 231. The node 231 is between the first energy storing circuit 50 and the second energy storing circuit 60. The third switch 24 includes a third gate 241, a third drain 242, and the third source 243. The third gate 241 receives the third control signal output from the third terminal 93 and controls the third switch 24 to switch on or off according to the third control signal. The third source 243 is electronically coupled to a node 232. The node 232 is between the second drain 222 and the first energy storing sub-unit 23. The third drain 242 is electronically connected to the first voltage output terminal 70 via the first unidirectional circuit 25. In the embodiment, the first unidirectional circuit 25 is a diode, and includes a first anode 251 and a first cathode 252. The first unidirectional circuit 25 turns on when a voltage of the second anode 251 is greater than a voltage of the second cathode 252, and turns off when the voltage of the second anode 251 is less than the voltage of the second cathode 252. The first anode 251 is electronically connected to the third drain 242, and the first cathode 252 is electronically connected to the first voltage output terminal 70.

In the embodiment, the second unidirectional circuit 26 includes a second anode 261 and a second cathode 262. The second unidirectional circuit 26 turns on when a voltage of the second anode 261 is greater than a voltage of the second cathode 262, and turns off when the voltage of the second anode 261 is less than the voltage of the second cathode 262. The second cathode 262 is electronically connected to the node 232. The fourth switch 27 includes a fourth gate 271, a fourth drain 272, and a fourth source 273. The fourth gate 271 receives the fourth control signal output from the fourth terminal 94 and controls the fourth switch 27 to switch on or off according to the fourth control signal. The fourth drain 272 is electronically connected to the second anode 261. The fourth source 273 is electronically connected to the second voltage output terminal 80.

The conversion of the first AC voltage into a first DC voltage is described below.

When the first AC voltage is in the positive period, the first switch 21 switches on during the first half period of the first control signal, and switches off during the second half period of the first control signal. The second switch 22 switches on when the first switch 21 switches on, and switches off when the first switch 21 switches off. That is, the second switch 22 switches on during the first half period of the second control signal, and switches off during the second half period of the second control signal. The third switch 24 switches off during the first half period of the third control signal and during the second half period of the third control signal. The fourth switch 27 switches off during the first half period of the fourth control signal, and switches on during the second half period of the fourth control signal. When the first AC voltage is in the positive period, the first energy storing sub-circuit 23 stores energy during the first half period of the control signals. During the second half period of the control signals, the first energy storing sub-circuit 23 discharges to the second energy storing circuit 60, and the second energy storing circuit 60 stores energy.

When the first AC voltage is in the negative period, the first switch 21 switches on during the first half period of the first control signal, and switches off during the second half period of the first control signal. The second switch 22 switches on when the first switch 21 switches on, and the second switch 22 switches off when the first switch 21 switches off. That is, the second switch 22 switches on during the first half period of the second control signal, and the second switch 22 switches off during the second half period of the second control signal. The third switch 24 switches off during the first half period of the third control signal, and the third switch 24 switches on during the second half period of the third control signal. The fourth switch 27 switches off during the first half period and the second half period of the fourth control signal. When the first AC voltage is in the negative period, the first energy storing sub-unit 23 stores energy during the first half period of the control signals. During the second half period of the control signals, the first energy storing sub-circuit 23 discharges to the first energy storing circuit 50, and the first energy storing circuit 50 stores energy.

The first energy storing circuit 50 and the second energy storing circuit 60 are fully charged after a few periods of the first AC voltage. A time to fully charge the first energy storing circuit 50 and the second energy storing circuit 60 relates to a voltage value of the AC voltage, and a capacity of the first energy storing circuit 50 and the second energy storing circuit 60.

When the first energy storing circuit 50 and the second energy storing circuit 60 are fully charged, the principle of the rectifier circuit 100 is described in detail below.

When the first AC voltage is in a positive period, during the first half period of the control signals, the first energy sub-unit 23 is charged by the first AC voltage. At the same time, the first energy storing circuit 50 and the second energy storing circuit 60 discharge to the load 200 via the first output terminal 70. During the second half period of the control signals, the first energy sub-unit 23 discharges energy to the second energy storing circuit 60. At the same time, the first energy storing circuit 50 and the second energy storing circuit 60 discharge to the load 200 via the first output terminal 70.

When the first AC voltage is in a negative period, during the first half period of the control signals, the first energy sub-unit 23 is charged by the first AC voltage. At the same time, the first energy storing circuit 50 and the second energy storing circuit 60 discharge to the load 200 via the second output terminal 80. During the second half period of the control signals, the first energy sub-unit 23 discharges energy to the first energy storing circuit 50. At the same time, the first energy storing circuit 50 and the second energy storing circuit 60 discharge to the load 200 via the second output terminal 80. In the positive period and the negative period of the first AC voltage, when the first energy sub-unit 23 discharges to the first energy circuit 50 and the second energy storing circuit 60, a first DC voltage is generated. Thus, the first AC voltage is converted into a first DC voltage. The second AC voltage is converted into a second DC voltage by the second rectifier unit 30, and the third AC voltage is converted into a third DC voltage by the third rectifier unit 70 similar to the first AC voltage being converted into the first DC voltage by the first rectifier unit 20.

FIG. 4 is a waveform diagram of the first AC voltage, the second AC voltage, and the third voltage generated by the three-phase AC power supply of FIG. 1. A waveform “a” refers to a waveform of the first AC voltage, a waveform “b” refers to a waveform of the second AC voltage, and a waveform “c” refers to a waveform of the third AC voltage. Periods of the waveform a, the waveform b, and the waveform c are divided equally into three time periods: time period “T1,” time period “T2,” and time period “T3.” In each of the three time periods, two waveforms have a positive voltage while the third waveform has a negative voltage, or two waveforms have a negative voltage while the third waveform has a positive voltage. For example, at the first time period “T1,” the first AC voltage and the third AC voltage are positive, and the second AC voltage is negative. At a point “A,” the first energy storing circuit 50 is charged by the first energy storing sub-unit 23 of the second rectifier unit 30, and the second energy storing circuit 60 is charged by the first energy storing sub-units 23 of the first rectifier unit 20 and the third rectifier unit 40. At a point “B,” the first energy storing circuit 50 is charged by the first energy storing sub-unit 23 of the second rectifier unit 30, and the first energy storing sub-unit 23 of the third rectifier unit 40, and the second energy storing circuit 60 is charged by the first energy storing sub-unit 23 of the first rectifier circuit 20. Thus, energy storage in the first energy storing circuit 50 and the second energy storing circuit 60 are approximately the same. Therefore, the voltage output by the first energy storing circuit 50 and the second storing circuit 60 to the load 200 is steady.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A rectifier circuit, comprising:
a three-phase alternating current (AC) power supply generating a first AC voltage, a second AC voltage and a third AC voltage, a phase difference between the first AC voltage and the second AC voltage, the second AC voltage and the third AC voltage, the third AC voltage and the first AC voltage is 120 degrees;
a signal generating circuit generating control signals;
a first rectifier unit receiving the first AC voltage and converting the first AC voltage into a first direct current (DC) voltage;
a second rectifier unit receiving the second AC voltage and converting the second AC voltage into a second DC voltage;
a third rectifier unit receiving the third AC voltage and converting the third AC voltage into a third DC voltage;
a first voltage output terminal;
a second voltage output terminal;
a first energy storing circuit;
a second energy storing circuit, the first energy storing circuit and the second circuit connected in series and coupled between the first voltage output terminal and the second voltage output terminal, and the first energy storing circuit and the second circuit configured to drive a load between the first voltage output terminal and the second voltage output terminal;
wherein in a time point, a first one of the first energy storing circuit and the second energy storing circuit is charged by two of the first rectifier unit, the second rectifier unit and the third rectifier unit; and in the time point, a second one of the first energy storing circuit and the second energy storing circuit is charged by a remaining one of the first rectifier unit, the second rectifier unit and the third rectifier unit under control of the control signals.

2. The rectifier circuit according to claim 1, wherein each rectifier unit comprises a first energy sub-unit; the control signals are periodic signals, and each control signals comprise a first half period and a second half period in a cycle; during the positive period of each control signals, the first energy sub-unit of each rectifier circuit is charged by corresponding AC voltage during the first half period of corresponding control signals, and the first energy sub-unit of each rectifier unit discharges to the second energy storing circuit during the second half period of corresponding control signals.

3. The rectifier circuit according to claim 2, wherein during the negative period of each control signals, the first energy sub-unit of each rectifier unit is charged by corresponding AC voltage during the first half period of corresponding control signals, and the first energy sub-unit of each rectifier unit discharges to the first energy storing circuit during the second half period of corresponding control signals.

4. The rectifier circuit according to claim 2, wherein the signal generating circuit generates a first control signal, a second control signal, a third control signal and a fourth control signal; each of the rectifier unit comprises: first switch, a second switch, a third switch, a four switch and a first energy storing sub-unit; the first switch, the second switch and the first energy storing sub-unit are electronically couple in series and electronically coupled between the corresponding AC voltage output terminal and the common terminal; the third switch is electronically coupled between the first voltage output terminal and a node formed between the second switch and the first energy storing sub-unit; the fourth switch is electronically coupled between the node and the common terminal; during the positive period of corresponding AC voltage, the first switch switches on during the first half period of the first control signal and switches off during the second half period of the first control signal; the second switch switches on when the first switch switches on and switches off when the first switch switches off under control of the second control signal; the third switch switches off both during the first half period and during the second half period of the control signal under control of the third control signal; the fourth switch switches off during the first half period of the control signal and switches on during the second period of the fourth control signal.

5. The rectifier circuit according to claim 4, wherein during the negative period of corresponding AC voltage the first switch switches on during the first half period of the first control signal and switches off during the second half period of the first control signal; the second switch switches on when the first switch switches on and switches off when the first switch switches off; the third switch switches off during the first half period of the third control signal, and switches on during the second half period of the third control signals; the fourth switch switches off both during the first half period and the second half period of the fourth control signal.

6. The rectifier according to claim 4, wherein each rectifier unit further comprises a first unidirectional circuit and a second unidirectional circuit; the first unidirectional circuit comprises a first anode and a first cathode, the first anode is electronically coupled to the third switch, the first cathode is electronically coupled to the first voltage output terminal; when an voltage of the first anode is greater than an voltage value of the first cathode, the first unidirectional circuit is on; when the voltage value of the first anode is less than the voltage of the first cathode, the first unidirectional circuit is off; the second unidirectional circuit comprises a second anode and a second cathode, the second anode is electronically coupled to the fourth switch, the second cathode is electronically coupled to the node; when an voltage of the second anode is greater than an voltage value of the second cathode, the second unidirectional circuit is on; when the voltage value of the second anode is less than the voltage of the second cathode, the second unidirectional circuit is off.

7. The rectifier circuit according to claim 4, wherein the first switch, the second switch, the third switch and the fourth switch are n-channel metal oxide semiconductor (NMOS) field effect transistors (FET).

8. The rectifier circuit according to claim 4, wherein the first energy storing sub-unit is an inductor.

9. The rectifier circuit according to claim 1, wherein the first energy storing circuit and the second energy storing circuit are capacitors.

10. The rectifier circuit according to claim 1, wherein the control signals are pulse width modulation (PWM) signals.

11. A rectifier circuit, comprising:
a three-phase alternating current (AC) power supply generating a first AC voltage, a second AC voltage, a third AC voltage; the three-phase AC power supply comprising:
a common terminal;
a first AC output terminal outputting the first AC voltage corresponding with the common terminal;
a second AC output terminal outputting the second AC voltage corresponding with the common terminal;
a third AC output terminal outputting the third AC voltage corresponding with the common terminal; a phase difference between the first AC voltage and the second AC voltage, the second AC voltage and the third AC voltage, the third AC voltage and the first AC voltage is 120 degrees;
a first voltage output terminal;
a second voltage output terminal;
a first energy storing circuit;
a second energy storing circuit, the first energy storing circuit and the second circuit connected in series and coupled between the first output terminal and the second output terminal, and the first energy storing circuit and the second circuit configured to drive a load between the first voltage output terminal and the second voltage output terminal;
a first rectifier unit receiving the first AC voltage and converting the first AC voltage to a first direct current (DC) voltage;
a second rectifier unit receiving the second AC voltage and converting the second AC voltage to a second DC voltage;
a third rectifier unit receiving the third AC voltage and converting the third AC voltage to a third DC voltage;
wherein in a positive period of each AC voltage of the first AC voltage, the second AC voltage and the third AC voltage, one of the first energy storing circuit and the second energy storing circuit is charged by each rectifier unit of the first rectifier unit, the second rectifier unit and the third rectifier unit; in a negative period of each AC voltage, the rest one of the first energy storing circuit and the second energy storing circuit is charged by each rectifier unit of the first rectifier circuit, the second rectifier unit and the third rectifier unit under control of the control signals.

12. An electronic device, comprising:
a three-phase alternating current (AC) power supply generating a first AC voltage, a second AC voltage and a third AC voltage, a phase difference between the first AC voltage and the second AC voltage, the second AC voltage and the third AC voltage, the third AC voltage and the first AC voltage is 120 degrees;
a signal generating circuit generating control signals;
a first rectifier unit receiving the first AC voltage and converting the first AC voltage to a first direct current (DC) voltage;
a second rectifier unit receiving the second AC voltage and converting the second AC voltage to a second DC voltage;
a third rectifier unit receiving the third AC voltage and converting the third AC voltage to a third DC voltage;
a first voltage output terminal;
a second voltage output terminal;
a load electronically coupling between the first voltage output terminal and the second voltage output terminal;
a first energy storing circuit;
a second energy storing circuit, the first energy storing circuit and the second circuit connected in series and coupled between the first voltage output terminal and the second voltage output terminal, and the first energy storing circuit and the second circuit configured to drive a load between the first voltage output terminal and the second voltage output terminal;
wherein in a time point, a first one of the first energy storing circuit and the second energy storing circuit is charged by two of the first rectifier unit, the second rectifier unit and the third rectifier unit; and in the time point, a second one of the first energy storing circuit and the second energy storing circuit is charged by a remaining one of the first rectifier unit, the second rectifier unit and the third rectifier unit under control of the control signals.

13. The electronic device according to claim 12, wherein each rectifier unit comprises a first energy sub-unit; the control signals are periodic signals, and each control signals comprise a first half period and a
second half period in a cycle; during the positive period of each control signals, the first energy sub-unit of each rectifier unit is charged by corresponding AC voltage during the first half period of corresponding control signals, and the first energy sub-unit of each rectifier unit discharges to the second energy storing circuit during the second half period of corresponding control signals.

14. The electronic device according to claim 13, wherein during the negative period of each control signals, the first energy sub-unit of each rectifier unit is charged by corresponding AC voltage during the first half period of corresponding control signals, and the first energy sub-unit of each rectifier unit discharges to the first energy storing circuit during the second half period of corresponding control signals.

15. The electronic device according to claim 13, wherein the signal generating circuit generates a first control signal, a second control signal, a third control signal and a fourth control signal; each of the rectifier unit comprises: first switch, a second switch, a third switch, a four switch and a first energy storing sub-unit; the first switch, the second switch and the first energy storing sub-unit are electronically couple in series and electronically coupled between the corresponding AC voltage output terminal and the common terminal; the third switch is electronically coupled between the first voltage output terminal and a node formed between the second switch and the first energy storing sub-unit; the fourth switch is electronically coupled between the node and the common terminal; during the positive period of corresponding AC voltage, the first switch switches on during the first half period of the first control signal and switches off during the second half period of the first control signal; the second switch switches on when the first switch switches on and switches off when the first switch switches off under control of the second control signal; the third switch switches off both during the first half period and during the second half period of the control signal under control of the third control signal; the fourth switch switches off during the first half period of the control signal and switches on in the second period of the fourth control signal.

16. The electronic device according to claim 15, wherein during the negative period of corresponding AC voltage the first switch switches on during the first half period of the first control signal and switches off during the second half period of the first control signal; the second switch switches on when the first switch switches on and switches off when the first switch switches off; the third switch switches off during the first half period of the third control signal, and switches on during the second half period of the third control signals; the fourth switch switches off both during the first half period and the second half period of the fourth control signal.

17. The electronic device according to claim 15, wherein each rectifier unit further comprises a first unidirectional circuit and a second unidirectional circuit; the first unidirectional circuit comprises a first anode and a first cathode, the first anode is electronically coupled to the third switch, the first cathode is electronically coupled to the first voltage output terminal; when an voltage of the first anode is greater than an voltage value of the first cathode, the first unidirectional circuit is on; when the voltage value of the first anode is less than the voltage of the first cathode, the first unidirectional circuit is off; the second unidirectional circuit comprises a second anode and a second cathode, the second anode is electronically coupled to the fourth switch, the second cathode is electronically coupled to the node; when an voltage of the second anode is greater than an voltage value of the second cathode, the second unidirectional circuit is on; when the voltage value of the second anode is less than the voltage of the second cathode, the second unidirectional circuit is off.

18. The electronic device according to claim 15, wherein the first switch, the second switch, the third switch and the fourth switch are n-channel metal oxide semiconductor (NMOS) field effect transistors (FET), the first energy storing sub-unit is an inductor.

19. The electronic device according to claim 12, wherein the first energy storing circuit and the second energy storing circuit are capacitors.

20. The electronic device according to claim 12, wherein the control signals are pulse width modulation (PWM) signals.
